(19) United States
(12) Patent Application Publication
(10) Pub. No.: US 2024/0419991 A1
(43) Pub. Date: Dec. 19, 2024

(54) METHOD OF PROVIDING MODEL SERVICES

(71) Applicant: BEIJING BAIDU NETCOM SCIENCE TECHNOLOGY CO., LTD., BEIJING (CN)

(72) Inventors: Zhenfang CHU, BEIJING (CN); Zhengyu QIAN, BEIJING (CN); En SHI, BEIJING (CN); Mingren HU, BEIJING (CN); Zhengxiong YUAN, BEIJING (CN); Jinqi LI, BEIJING (CN); Yue HUANG, BEIJING (CN); Yang LUO, BEIJING (CN); Guobin WANG, BEIJING (CN); Yang QIAN, BEIJING (CN); Kuan WANG, BEIJING (CN)

(73) Assignee: BEIJING BAIDU NETCOM SCIENCE TECHNOLOGY CO., LTD., BEIJING (CN)

(21) Appl. No.: 18/747,725

(22) Filed: Jun. 19, 2024

(30) Foreign Application Priority Data
Mar. 20, 2024 (CN) 202410324021.2

(51) Int. Cl. G06N 5/04

(52) U.S. Cl. CPC G06N 5/04

(57) ABSTRACT

A method is provided that includes: creating a plurality of first model instances of a first service model to be deployed; allocating an inference service for each of a plurality of first model instances from the plurality of inference services; calling, for each first model instance, a loading interface of the inference service allocated for the first model instance to mount a weight file; determining, in response to a user request for a target service model, a target model instance from a plurality of model instances of the target service model to respond to the user request; and calling a target inference service allocated for the target model instance to use computing resources configured for the target inference service to run, in the target model instance, a base model mounted with a target weight file, and obtain a request result of the user request.

### CROSS-REFERENCE TO RELATED APPLICATIONS

The present application claims priority to Chinese Patent Application No. 202410324021.2, filed on Mar. 20, 2024, which is incorporated herein by reference in its entirety.

### TECHNICAL FIELD

The present disclosure relates to the field of computer technologies, particularly, to the field of large model technologies, and in particular, to a model service providing method, an electronic device, and a non-transitory computer-readable storage medium.

### BACKGROUND ART

Nowadays, AI-generated content (AIGC) technologies based on large models are rapidly empowered in all walks of life, and the demand for scenization and customization of AIGC is increasing. For example, medical question answering, legal consulting, and other scenarios are all expected to have large model services that fit the service scenarios.

In addition, to provide better model services for users, various model service providing platforms have emerged. These model service providing platforms are generally deployed with a large number of large models for various service scenarios, to provide users with various model services.

### SUMMARY

The present disclosure provides a method and platform for providing model service based on a large model technology, and an electronic device.

According to an aspect of the present disclosure, there is provided a method for providing model service, including:
creating a plurality of first model instances of a first service model to be deployed, wherein the first service model is a large model generated based on a base model;
allocating an inference service for each of the plurality of first model instances from the plurality of inference services, wherein the plurality of inference services are obtained by encapsulating the base model, and each inference service of the plurality of inference services is configured with independent computing resources;
calling, for each first model instance of the plurality of first model instances, a loading interface of the inference service allocated for the first model instance to mount a weight file of the first service model to the base model encapsulated in the inference service allocated for the first model instance;
determining, in response to a user request for a target service model, a target model instance from a plurality of model instances of the target service model to respond to the user request; and
calling a target inference service allocated for the target model instance to use computing resources configured for the target inference service to run, in the target model instance, a base model mounted with a target weight file, and obtain a request result of the user request, wherein the target weight file is a weight file of the target service model.

According to another aspect of the present disclosure, there is provided an electronic device, including:
at least one processor; and
a memory communicatively connected to the at least one processor, wherein
the memory stores instructions executable by the at least one processor, and the instructions, when executed by the at least one processor, cause the at least one processor to perform the following operations:
creating first model instances of a first service model to be deployed, wherein the first service model is a large model generated based on a base model;
allocating inference services for the first model instances, wherein the inference services are services obtained by encapsulating the base model, and each inference service is configured with independent computing resources;
calling a loading interface of the inference service allocated for the first model instance to mount a weight file of the first service model to the base model encapsulated in the allocated inference service;
determining, in response to a user request for a target service model, a target model instance used to respond to the user request from model instances of the target service model; and
calling a target inference service allocated for the target model instance to use configured computing resources to run, in the target model instance, a base model mounted with a target weight file, and obtain a request result of the user request, wherein the target weight file is a weight file of the target service model.

According to another aspect of the present disclosure, there is provided a non-transitory computer-readable storage medium storing computer instructions, where the computer instructions are used to cause the computer to perform operations based on a model service providing platform, wherein the model service providing platform includes a plurality of inference services, and wherein the operations comprises:
creating first model instances of a first service model to be deployed, wherein the first service model is a large model generated based on a base model;
allocating inference services for the first model instances, wherein the inference services are services obtained by encapsulating the base model, and each inference service is configured with independent computing resources;
calling a loading interface of the inference service allocated for the first model instance to mount a weight file of the first service model to the base model encapsulated in the allocated inference service;
determining, in response to a user request for a target service model, a target model instance used to respond to the user request from model instances of the target service model; and
calling a target inference service allocated for the target model instance to use configured computing resources to run, in the target model instance, a base model mounted with a target weight file, and obtain a request result of the user request, wherein the target weight file is a weight file of the target service model.

It should be understood that the content described in this section is not intended to identify critical or important features of the embodiments of the present disclosure, and is not used to limit the scope of the present disclosure. Other features of the present disclosure will be readily understood with reference to the following description.

### BRIEF DESCRIPTION OF THE DRAWINGS

The accompanying drawings are used for a better understanding of the solutions, and do not constitute a limitation on the present disclosure. In the accompanying drawings:

FIG. 1 is a schematic diagram of a structure of a model service providing platform according to an embodiment of the present disclosure;

FIG. 2 is a schematic flowchart of a workflow of modules in a first platform according to an embodiment of the present disclosure:

FIG. 3 is a schematic flowchart of a workflow of modules in a second platform according to an embodiment of the present disclosure:

FIG. 4 is a schematic flowchart of a workflow of modules in a third platform according to an embodiment of the present disclosure:

FIG. 5 is a schematic flowchart of a first model service providing method according to an embodiment of the present disclosure:

FIG. 6 is a schematic flowchart of a second model service providing method according to an embodiment of the present disclosure:

FIG. 7 is a schematic flowchart of a third model service providing method according to an embodiment of the present disclosure; and

FIG. 8 is a block diagram of an electronic device for implementing a model service providing method according to an embodiment of the present disclosure.

### DETAILED DESCRIPTION OF EMBODIMENTS

Example embodiments of the present disclosure are described below in conjunction with the accompanying drawings, where various details of the embodiments of the present disclosure are included to facilitate understanding, and should only be considered as examples. Therefore, those of ordinary skill in the art should be aware that various changes and modifications can be made to the embodiments described herein, without departing from the scope and spirit of the present disclosure. Likewise, for clarity and conciseness, the description of well-known functions and structures is omitted in the following description.

A model service providing platform (hereinafter referred to as “platform”) is used to provide various model services for users. Large models used in these model services are usually generated based on a base model provided by the platform, and the base model may be understood as a general model that is pre-created on the platform, obtained through training, and used to process user requests in various scenarios. Although the base model can be used to process user requests in various scenarios, a degree of scenization (or a degree of customization) of the base model is relatively low, and the accuracy of processing the user requests in various scenarios is relatively low.

In view of this, to meet the current demands of scenization and customization, the platform itself or a model developer may train, based on the base model, a service model that is specialized for a specific scenario, so that the service model can be used to process user requests in the specific scenario, which can improve the request processing accuracy.

There are two modes to obtain a service model through training based on a base model:

First mode: Small-scale weights are added to large-scale weights of the base model. During a training process, the original large-scale weights are kept unchanged and only the added small-scale weights are adjusted and optimized until training is completed, to obtain the service model.

For example, the base model may have tens of millions of weights originally. In this case, thousands of weights may be added to the tens of millions of weights. During a training process, the original tens of millions of weights are kept unchanged, and only the thousands of added weights are adjusted and optimized until training is completed.

Second mode: During a training process, only a small part of the weights of the base model are adjusted until training is completed to obtain the service model.

For example, the base model may have tens of millions of weights originally. During a training process, only thousands of weights in the tens of millions of weights are adjusted until training is completed.

In the related art, after the service model is obtained through training, the platform configures independent computing resources for the service model, such as GPU resources, CPU resources, etc., so that in the subsequent process of using the service model to provide model services for users, the configured computing resources may be used to run the service model to provide the model services for the users. However, with more and more extensive application scenarios of models, various service models are growing massively. If independent computing resources are configured for each service model, the platform needs to consume a lot of computing resources.

Embodiments of the present disclosure provide a model service providing method and platform based on a large model technology, and an electronic device.

Firstly, some concepts mentioned in the embodiments of the present disclosure are explained.

### 1. Inference Service

A large model itself is only a file with weights. The platform needs to encapsulate the large model into an inference service, and configure computing resources for the inference service, so that the large model can be used to perform model inference. The inference service has various interfaces. When the platform calls the service, various interfaces exposed by the inference service may be called to perform various operations.

For example, during the process of responding to a user request, the platform may call an input interface of the inference service. The inference service uses computing resources to obtain data to be processed through the input interface. After model inference is performed on the input data by using the large model, a model inference result may be obtained from an output interface of the inference service.

When the large model is encapsulated into the inference service, a weight file of the large model may be input to a pre-constructed service framework to obtain the inference service.

In addition, the platform may encapsulate a same large model into one or more inference services. When the platform performs encapsulation to obtain a plurality of inference services, computing resources may be configured for each inference service, so that when the platform receives a plurality of requests, the plurality of inference services may be called to use the computing resources configured for the plurality of inference services to process the plurality of requests in parallel.

### 2. Model Instance

A model instance, or a model copy may be understood as an object that is actually used to process a request in the platform. A plurality of model instances may be created for one large model, and each model instance may be used to process a request, so that the plurality of model instances may be used to process a plurality of requests in parallel.

A model service providing method and platform based on a large model technology, and an electronic device will be described in detail below through specific embodiments.

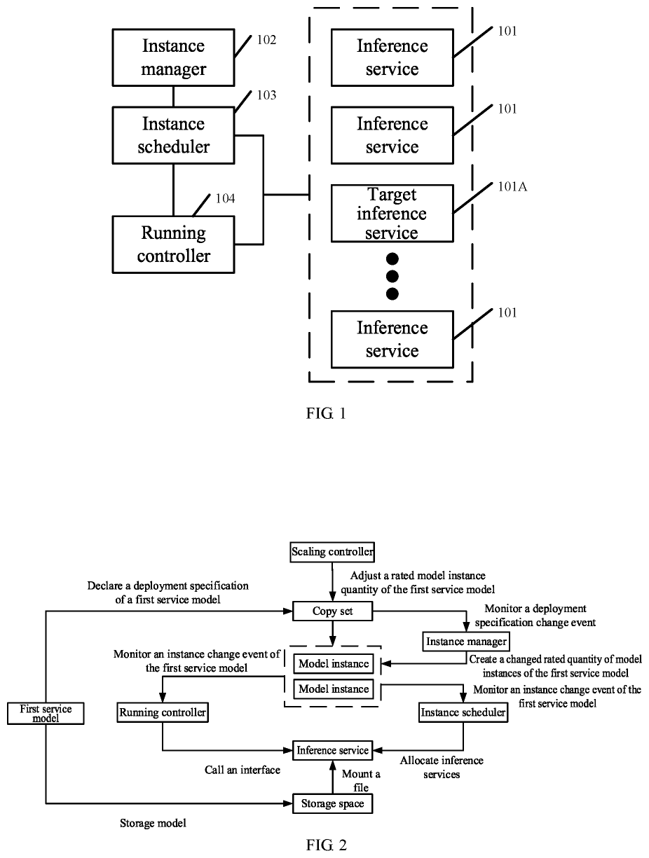

Refer to FIG. 1. FIG. 1 is a schematic diagram of a structure of a first model service providing platform provided by an embodiment of the present disclosure. In this embodiment, the platform includes inference services 101 obtained by encapsulating a base model that is supported by the platform, an instance manager 102, an instance scheduler 103, and a running controller 104. Each inference service 101 is configured with independent computing resources.

The above modules included in the platform will be described below one by one.

### 1. Inference Service 101

The inference services 101 are services obtained by encapsulating a base model that is supported by the platform, and each inference service 101 is configured with independent computing resources.

For the description of the inference service 101, reference may be made to the above content, and details are not described herein again.

### 2. Instance Manager 102

The instance manager 102 is used to create first model instances of a first service model to be deployed.

The first service model is a large model generated based on a base model.

It can be learned from the above content that the first service model is a service model that is obtained through training based on the base model and specialized for a specific scenario.

One first service model corresponds to one specific scenario, and different specific scenarios correspond to different first service models.

For example, the above first service model may be a service model specialized for a medical question answering scenario, or may be a service model specialized for a legal consulting scenario. The first service models for the two scenarios are different.

Specifically, the above first service model may be stored in a storage space of the platform. The instance manager 102 may obtain a storage address, a model ID, model version meta information, and other information of the first service model, and create first model instances of the first service model based on the obtained information.

### 3. Instance Scheduler 103

The instance scheduler 103 is used to allocate inference services 101 for first model instances.

A first service model is used to process user requests in a specific scenario, and the platform needs to encapsulate the first service model into services to use the first service model. The above inference services 101 are services obtained by encapsulating a base model. If the inference services 101 need to be called subsequently to process user requests in a specific scenario, only the base model can be used to process the requests. Therefore, the inference services 101 need to be allocated for the first model instances of the first service model, so that the first service model can be used to process the requests when the inference services 101 are called subsequently.

When inference services 101 are allocated for first model instances, a plurality of first model instances of a same first service model may be allocated to different inference services 101, and first model instances of different first service models may be allocated to the same or different inference services 101.

For example, a first service model corresponding to a medical question answering scenario is referred to as model A, and a first service model corresponding to a legal consulting scenario is referred to as model B. The instance manager 102 may create a plurality of model instances of model A, such as three model instances, namely, instances A1, A2, and A3. Therefore, when the instance scheduler 103 allocates inference services 101 for the three model instances, the three model instances may be allocated to three different inference services 101.

The instance manager 102 may further create a model instance of model B, such as a model instance that is referred to as instance B1. Therefore, when the instance scheduler 103 allocates an inference service 101 for instance B1, the instance B1 may be allocated to the inference service 101 where the instance A1, A2 or A3 is located.

For the specific implementation of allocating the inference services 101 for the first model instances, reference may be made to subsequent embodiments, and details are not described herein.

### 4. Running Controller 104

The running controller 104 is used to call a loading interface of an inference service 101 allocated for a first model instance to mount a weight file of the first service model to a base model encapsulated in the allocated inference service 101.

The inference service 101 includes not only an input interface and an output interface, but also the loading interface used to obtain the weight file of the model from the outside of the service. The running controller 104 calls the loading interface of the inference service 101 allocated for the first model instance, the inference service 101 may load the weight file of the first service model corresponding to the first model instance through the interface, and mount the loaded weight file to the encapsulated base model. When encapsulating is completed, it means that deployment of the first model instance is completed. When all first model instances of the first service model are deployed, it means that deployment of the first service model is completed.

In an embodiment of the present disclosure, the above weight file may be a file containing small-scale weights to be adjusted and optimized in the first service model. If the first service model is obtained through the above first mode for obtaining a service model, when the weight file is mounted to the base model, weights in the weight file and locations in the base model may be utilized to replace weights at the same locations in the base model.

If the first service model is obtained through the above second mode for obtaining a service model, when the weight file is mounted to the base model, weights in the weight file may be directly added based on weights of the base model.

In addition, the running controller 104 may be further used to receive a user request for a target service model, and determine a target model instance used to respond to the user request from model instances of the target service model.

After deployment of the first service model is completed, the platform may begin to process user requests in a scenario corresponding to the first service model. The above target service model belongs to the deployed first service model.

Specifically, the running controller 104 may monitor a state of each first model instance of each deployed first service model. For example, the states of the first model instances may include an idle state and a working state. Therefore, when a user request for a target service model is received, a model instance in the idle state may be determined from model instances of the target service model to serve as a target model instance used to respond to the user request.

When each model instance is in the working state, the quantity of pending requests of each model instance may be further obtained, and a model instance with fewer pending requests may be determined as the target model instance.

### 5. Target Inference Service 101A Allocated for Target Model Instance

A target inference service 101A allocated for a target model instance is used to use configured computing resources to run, in the target model instance, a base model mounted with a target weight file, and obtain a request result of the user request.

The target weight file is a weight file of the target service model.

The running controller 104 determines the target model instance, that is, the target inference service 101A that is allocated for the target model instance and used to process a current user request is determined. Therefore, the platform may call an input interface of the target inference service 101A. The target inference service 101A uses the configured computing resources to obtain data to be processed in the above user request through the input interface. After model inference is performed on the input data by using a target service model encapsulated in the target inference service 101A, a model inference result may be output from an output interface of the target inference service 101A, that is, a request result of the user request is obtained.

It can be learned from the above description that when the solution provided by the embodiment of the present disclosure is applied to providing model services, each inference service 101 is configured with independent computing resources, and inference services 101 are allocated for first model instances of each first service model, so that the base model encapsulated in the allocated inference service 101 is mounted with the weight file of the first service model. When the user request for the target service model is received, the target inference service 101A to which the target model instance is allocated can use the configured computing resources to run the base model mounted with the weight file of the target service model. Hence, in the embodiment of the present disclosure, for each user request, the target model instance can be directly determined, and then the target inference service 101A to which the target model instance is allocated uses the computing resources to run the model, so that the purpose of effectively utilizing the computing resources is achieved.

A plurality of specific implementations in which the instance scheduler 103 allocates inference services 101 for first model instances are described below.

In the first implementation, the instance scheduler 103 allocates each first model instance to a different inference service 101 based on a quantity of model instances allocated to each inference service 101.

Specifically, the instance scheduler 103 is used to allocate the inference services 101 for the first model instances. Therefore, the instance scheduler 103 may record allocation relationships between allocated model instances and inference services 101, so that when the inference services 101 are allocated for the first model instances, the quantity of model instances allocated to each inference service 101 may be counted, and each first model instance may be allocated to a different inference service 101 based on the counted quantities.

For example, the first model instances are allocated to the inference service 101 to which the fewest model instances are allocated based on the counted quantities.

In this solution, the more model instances allocated to the inference service 101, the more times the model instance allocated to the service is determined as the target model instance when responding to various requests, and the more frequently the computing resources configured for the service are used. Accordingly, the fewer model instances allocated to the inference service 101, the less frequently the computing resources configured for the service are used. The inference services 101 are allocated for the first model instances based on the quantity of model instances allocated to each inference service 101, which can guarantee that a relatively uniform quantity of model instances are allocated to each inference service 101, so that a usage frequency of computing resources configured for each inference service 101 is not much different, and the situation that computing resources configured for some services are busy and computing resources configured for some services are idle can be avoided. Therefore, by applying the solution provided by the embodiment of the present disclosure to providing model services, the computing resources of the platform can be effectively utilized.

In the second implementation, the instance scheduler 103 allocates each first model instance to a different inference service 101 based on a quantity of idle resources in computing resources configured for each inference service 101.

Specifically, each inference service 101 may periodically detect the usage of own computing resources. The instance scheduler 103 may obtain the latest quantity of idle resources detected by each inference service 101 itself, so that each first model instance may be allocated to a different inference service 101 with more idle resources based on the obtained quantity of idle resources for each inference service 101.

For example, for each first model instance, an inference service 101 with the maximum idle resources and to which model instances of the same first service model are not allocated may be determined, and the first model instance is allocated to the inference service 101.

For another example, for each first model instance, inference services 101 whose quantities of idle resources exceed a preset threshold and to which model instances of the same first service model are not allocated may be determined from the inference services 101, and the first model instance is allocated to any of the determined inference services 101.

In this solution, the inference services 101 are allocated based on the quantity of the idle resources in the computing resources configured for each inference service 101, so that the computing resources of the platform can be effectively utilized.

In the third implementation, the instance scheduler 103 allocates each first model instance to a different inference service 101 based on the quantity of instances allocated to each inference service 101 and the quantity of idle resources in computing resources configured for each inference service 101.

Specifically, for each first model instance, the instance scheduler 103 allocates the first model instance to an inference service 101 with fewer allocated instances and more idle resources and to which model instances of the same first service model are not allocated, so that the computing resources of the platform are utilized to the greatest extent.

In the fourth implementation, the instance scheduler 103 allocates different inference services from first inference services for first model instances.

A base model encapsulated in the first inference services is a first base model, and the first base model is a base model based on which a first service model is generated.

Specifically, there may be a plurality of base models developed by the platform. In this case, the platform may support a plurality of inference services. In addition, for each base model, inference services that encapsulate the base model need to be allocated for a service model generated based on the base model.

For example, if the platform develops base models J1 and J2, service models C1 and C2 are generated based on the base model J1, and a service model DI is generated based on the base model J2, when inference services are allocated for model instances of the service models, model instances of the service models C1 and C2 are allocated to inference services that encapsulate the base model J1, and model instances of the service model DI are allocated to inference services that encapsulate the base model J2.

In this solution, the instance scheduler 103 allocates the different inference services from the first inference services for the first model instances, and the first inference service encapsulates the first base model based on which the first service model is generated, and the first model instances are model instances of the first service model, so that the inference service can be accurately allocated for each first model instance based on relationships between the first base model, the first service model, the first inference services and the first model instances, thereby improving the accuracy of providing model services.

In the fifth implementation, the instance scheduler 103 queries candidate inference services to which model instances of a first service model are not allocated, and allocates the candidate inference services for first model instances.

A plurality of model instances of a same first service model need to be allocated to different inference services 101. If the plurality of model instances of the same first service model are allocated to a same inference service 101, each of the plurality of model instances needs to use computing resources configured for this inference service 101 when serving as a target model instance. As a result, the computing resources configured for this inference service 101 are busy, whereas computing resources configured for other inference services 101 are idle.

In view of the above situation, when allocating the candidate inference services for the first model instances, the instance scheduler 103 may query candidate inference services to which model instances of the first service model are not allocated, and allocate the candidate inference services for the first model instances.

For example, if the instance manager 102 creates three model instances of a first service model, namely, instance C1, instance C2 and instance C3, the platform provides three inference services S1, S2 and S3. If the instance scheduler 103 allocates inference service S1 for instance C1, the instance scheduler can query that inference services C2 and C3 are candidate inference services when allocating an inference service for instance C2, so that one of inference services S2 and S3 may be allocated for instance C2.

In this solution, first, the candidate inference services to which the model instances of the first service model are not allocated are queried, and then the candidate inference services are allocated for the first model instances, which can avoid the plurality of model instances of the first service model being allocated to the same inference service, and avoid the situation that computing resources configured for a part of the inference services are busy whereas computing resources configured for a part of the inference services are idle, so that the computing resources of the platform can be effectively utilized.

The instance manager 102, the instance scheduler 103 and the running controller 104 may carry out work of each link through communication connections therebetween. For example, after creating a first model instance, the instance manager 102 notifies the instance scheduler 103 that the first model instance has been created. After receiving the notification that the first model instance has been created, the instance scheduler 103 may allocate an inference service 101 for the created first model instance, and notify the running controller 104 that the inference service 101 has been allocated for the first model instance. After receiving the notification that the inference service 101 is allocated for the first model instance, the running controller 104 may perform the operations of calling a loading interface and mounting a weight file.

In addition, the instance manager 102, the instance scheduler 103 and the running controller 104 may alternatively trigger work of each model through state transition of first model instances.

In an embodiment of the present disclosure, the instance manager 102 may be further used to monitor a state of each first model instance.

The instance scheduler 103 is used to allocate an inference service 101 for a first model instance whose state represents that the first model instance has been created but a service is not allocated for the first model instance.

The running controller 104 is used to determine a first model instance whose state represents that a service has been allocated for but not bound to the inference service 101, and call a loading interface of an inference service 101 allocated for the determined first model instance to mount a weight file of the first service model to the base model encapsulated in the allocated inference service 101.

When the instance manager 102 completes creating of a first model instance, the instance manager 102 may determine that the state of the first model instance at this time is a state representing that the first model instance has been created but an inference service is not allocated for the first model instance.

After the instance scheduler 103 allocates an inference service 101 for the first model instance, the instance manager 102 may determine that the state of the first model instance at this time is a state representing that the inference service has been allocated for but not bound to the inference service 101.

When the running controller 104 calls a loading interface of the inference service 101 to mount the weight file of the first service model corresponding to the first model instance to the base model encapsulated in the inference service 101, the instance manager 102 may determine that the state of the first model instance at this time is a bound state.

In view of this, the states of the first model instances of the first service model may be diverse. When working, the instance scheduler 103 determines, from the first model instances, a first model instance whose state represents that the first model instance has been created but a service is not allocated for the first model instance, and then allocates an inference service 101 for the determined first model instance.

Similarly, the running controller 104 determines, from the first model instances, a first model instance whose state represents that a service has been allocated for but not bound to the inference service 101, and then calls a loading interface of an inference service 101 allocated for the determined model instance to mount the weight file of the first service model to the base model encapsulated in the allocated inference service 101.

It can be learned from the above description that when the solution provided by the embodiment of the present disclosure is applied to providing model services for users, the instance manager 102 monitors the state of each first model instance. The instance scheduler 103 and the running controller 104 accurately determine respective first model instances needing to be processed based on the state of each first model instance, and process the determined first model instances accordingly. Hence, applying the model service providing solution provided by the embodiment of the present disclosure can improve the accuracy of providing model services for users.

After the running controller 104 calls the loading interface of the inference service 101 to mount the weight file of the first service model to the base model encapsulated in the inference service 101, the inference service 101 can be used to process a user request in a scenario corresponding to the first service model mounted with the weight file, and the inference service 101 is hardly used to process a user request in a scenario corresponding to the first service model not mounted with the weight file.

In view of this, in an embodiment of the present disclosure, when determining a target model instance, the running controller 104 may obtain a model list of the first service model corresponding to model instances allocated to each inference service 101, receive a user request for the target service model, determine, based on the model list, model instances, of the target service model, for which inference services are allocated, and obtain the target model instance used to respond to the user request from the determined model instances.

Specifically, when mounting the weight file of the first service model to the base model encapsulated in the inference service 101, the running controller 104 may record the first service model of the weight file mounted to the base model encapsulated in each inference service 101 to obtain a model list of the first service model corresponding to the model instances allocated to each inference service 101. The first service model in the model list corresponding to each inference service 101 is actually the first service model corresponding to a scenario of user requests that can be processed by each inference service 101, so that after receiving the user request for the target service model, which inference services 101 can be used to process the received user request can be accurately determined based on the model list corresponding to each inference service 101. After the inference services 101 that can be used to process the received user request are determined, model instances of the target service model allocated to these inference services 101 can be determined, and the target model instance used to respond to the user request can be obtained from the determined model instances.

It can be learned from the above description that when the solution provided by the embodiment of the present disclosure is applied to providing model services for users, the model instances, of the target service model, for which the inference services 101 are allocated can be accurately determined based on the model list, so that the target model instance used to responds to the user request can be accurately obtained from the determined instances, and then the accuracy of providing model services for users can be improved based on the target model instance.

After deployment of the first service model is completed, the deployed service model can be operated and maintained based on steps mentioned in the following embodiment.

In an embodiment of the present disclosure, the instance manager 102 is further used to determine whether a rated quantity for model instances and a quantity of model instances which have been created of a deployed second service model are consistent, and if the quantities are inconsistent, create a target quantity of model instances of the second service model in a case that the quantity of model instances which have been created is less than the rated quantity for model instances.

The rated quantity for model instances of the second service model is a quantity of model instances of the second service model that are expected to be deployed in the platform.

The rated quantity for model instances of the second service model may be a preset instance quantity.

The target quantity is a difference between the quantity of model instances which have been created and the rated quantity for model instances.

Specifically, in a case of determining that the rated quantity for model instances and the quantity of model instances which have been created of the deployed second service model are inconsistent, the instance manager 102 may compare the sizes of the two instance quantities, and calculate a difference between the two instance quantities to obtain the target quantity. If a result that the quantity of model instances which have been created is less than the rated quantity for model instances is obtained through the comparison, the target quantity of model instances of the second service model are created. If a result that the quantity of model instances which have been created is greater than the rated quantity for model instances is obtained through the comparison, the target quantity of model instances of the second service model are deleted, so that the quantity of the model instances of the second service model is kept at the rated quantity for model instances.

For trigger situations for determining, by the instance manager 102, that the rated quantity for model instances of the deployed second service model is inconsistent with the quantity of model instances which have been created, reference may be made to subsequent embodiments, and details are not described herein.

The deleting the target quantity of model instances of the second service model may be implemented in any of the following four implementations.

In the first implementation, after an inference service 101 allocated for each model instance of the second service model is determined, quantities of model instances allocated to these inference services are obtained, a target quantity of inference services 101 to which the maximum quantity of model instances are allocated are determined, and the model instances of the second service model allocated to the determined inference services 101 are deleted.

In the second implementation, after an inference service 101 allocated for each model instance of the second service model is determined, quantities of idle resources in computing resources configured for these inference services 101 are obtained, a target quantity of inference services 101 with the fewest idle resources are determined, and model instances of the second service model allocated to the determined inference services 101 are deleted.

In the third implementation, after an inference service 101 allocated for each model instance of the second service model is determined, quantities of model instances allocated to these inference services 101 and quantities of idle resources in configured computing resources are obtained, a target quantity of inference services 101 are determined based on two types of information, namely, the quantities of the allocated model instances and the quantities of the idle resources, and model instances of the second service model allocated to the determined inference services 101 are deleted.

In the fourth implementation, a target quantity of model instances are randomly deleted from created model instances of the second service model.

Steps performed by the instance scheduler 103 and the running controller 104 when the instance manager 102 creates model instances or deletes model instances will be described below.

### 1. The Instance Manager 102 Creates a Target Quantity of Model Instances.

In this case, the instance scheduler 103 is further used to allocate inference services 101 for newly created model instances.

The running controller 104 is further used to call a loading interface of the inference service 101 allocated for the newly created model instance to mount a weight file of the second service model to a base model encapsulated in the allocated inference service 101.

For specific implementations of the instance scheduler 103 allocating the inference service 101 for the model instance and the running controller 104 calling the loading interface to mount the weight file of the second service model to the base model, reference may be made to the previous embodiments, and details are not described herein again.

In a case that a quantity of model instances which have been created of the second service model is less than a rated quantity for model instances, the instance manager 102 creates a target quantity of model instances of the second service model, and then the instance scheduler 103 and the running controller 104 separately perform the operations of allocating inference services 101 and calling loading interfaces, so that the created model instances of the second service model can reach the rated quantity for model instances, and the rated quantity for model instances may be understood as a quantity of model instances of the second service model that are expected to be deployed. Therefore, creating the target quantity of model instances can guarantee that deployment of the second service model meets expectations, thereby improving the reliability of providing model services.

### 2. The Instance Manager 102 Deletes a Target Quantity of Model Instances.

In this case, the instance scheduler 103 is further used to release allocation relationships between deleted model instances and inference services 101 allocated for the deleted model instances.

The running controller 104 is further used to call an unloading interface of the inference service 101 allocated for the deleted model instance, and delete a mounted weight file of the second service model from the base model encapsulated in the allocated inference service 101.

Specifically, when allocating inference services 101 for model instances, the instance scheduler 103 may record allocation relationships between the model instances and the inference services 101. After the instance manager 102 deletes a second quantity of model instances of the second service model, the instance scheduler 103 may determine and release allocation relationships between the model instances deleted by the instance manager 102 and the inference service 101 allocated for the deleted model instances according to the recorded allocation relationships.

After the instance manager 102 deletes the model instance, the running controller 104 may determine the deleted model instance, and determine an inference service 101 bound to the deleted model instance, to call an unloading interface of the determined inference service 101 to delete the mounted weight file of the second service model from the base model encapsulated in the inference services 101.

In a case that a quantity of model instances which have been created of the second service model is greater than a rated quantity for model instances, the instance manager 102 deletes a target quantity of model instances of the second service model, and then the instance scheduler 103 and the running controller 104 separately perform the operations of releasing allocation relationships and calling unloading interfaces, so that the created model instances of the second service model can reach the rated quantity for model instances, which can guarantee that deployment of the second service model meets expectations, thereby improving the reliability of providing model services.

The plurality of trigger situations for inconsistency between the rated quantity for model instances of the deployed second service model and the quantity of model instances which have been created are described below.

The first trigger situation: The platform further includes: a scaling controller. The scaling controller adjusts the rated quantity for model instances of the second service model based on monitored service traffic of the second service model.

The above service traffic of the second service model is a size of user requests processed in a scenario corresponding to the second service model within a preset time period by inference services 101 to which model instances of the second service model are allocated.

In an example in which the second service model is a medical question answering model corresponding to a medical question answering scenario, the above preset time period may be one hour, and the service traffic of the medical question answering model is a size of medical question answering requests processed within one hour by each inference service 101 with a medical question answering function. If each inference service 101 with the medical question answering function can process ten thousand medical question answering requests within one hour, a service traffic value of the medical question answering model is ten thousand.

Specifically, the scaling controller may monitor service traffic of each second service model, and adjust the rated quantity for model instances of the second service model based on the monitored service traffic of the second service model through any of the following two implementations.

In the first implementation, the scaling controller determines change information that represents a traffic change trend of the second service model based on the monitored service traffic of the second service model, and adjusts the rated quantity for model instances of the second service model based on the change information.

The scaling controller may periodically monitor service traffic of the second service model within each time period, determine the change information that represents the traffic change trend of the second service model, such as change information that represents continuous declining of the traffic of the second service model, change information that represents continuous rising of the traffic of the second service model, and change information that represents the traffic of the second service model firstly rising then declining or firstly declining then rising, based on the monitored service traffic of the second service model within each time period, and then adjust the rated quantity for model instances of the second service model based on the change information.

For example, if the change information represents that the traffic of the second service model declines continuously, it means that no more model instances need to be deployed for the second service model. In this case, the rated quantity for model instances of the second service model may be decreased.

If the change information represents that the traffic of the second service model rises continuously, it means that currently deployed model instances of the second service model hardly process all requests. In this case, the rated quantity for model instances of the second service model may be increased.

If the change information represents that the traffic of the second service model firstly rises then declines or firstly declines then rises, it means that the service traffic of the second service model fluctuates within an acceptable range of model instances of the second service model. In this case, the rated quantity for model instances of the second service model does not need to be adjusted.

In this implementation, the scaling controller determines the change information that represents a traffic change trend of the second service model based on the monitored service traffic of the second service model, and can adaptively adjust the rated quantity for model instances of the second service model based on the change information while considering the traffic change trend of the second service model. As the rated quantity for model instances is adjusted, a quantity of model instances which have been created of the second service model is inconsistent with the rated quantity for model instances, so that the instance manager 102, the instance scheduler 103 and the running controller 104 perform corresponding actions, and the quantity of model instances which have been created of the second service model can be adjusted with the traffic change trend, thereby avoiding the shortage or idleness of computing resources caused by too many model instances or too few model instances of the second service model. Therefore, applying the service model providing solution provided by the embodiment of the present disclosure can effectively utilize the computing resources of the platform.

Refer to FIG. 2. FIG. 2 shows a workflow of modules included in the platform.

It can be seen from FIG. 2 that after the platform or the model developer develops a first service model on the platform, on the one hand, the first service model is stored in a storage space of the platform, and on the other hand, a deployment specification of the first service model is declared in a copy set, that is, a rated quantity for model instances to be deployed of the first service model is determined. The copy set is used to record the rated quantity for model instances of each first service model.

In addition, for the rated quantity for model instances of the first service model recorded in the copy set, the scaling controller may further adjust the rated quantity for model instances of the first service model based on service traffic of the first service model.

If the deployment specification of the first service model in the copy set changes, that is, the rated quantity for model instances of the first service model changes, the instance manager 102 may monitor a deployment specification change event to create a changed rated quantity of model instances of the first service model.

After monitoring an instance change event of the first service model, the instance scheduler 103 may allocate inference services 101 for the created model instances of the first service model. After monitoring an instance change event of the first service model, the running controller 104 may call a loading interface of the inference service 101 allocated for the model instance of the first service model to mount the weight file of the first service model stored in the storage space to the base model encapsulated in the allocated inference service 101.

In the second implementation, the scaling controller compares the monitored service traffic of the second service model with a maximum value and a minimum value of a preset service traffic range. If the service traffic is less than the minimum value of the preset service traffic range, it means that no more model instances need to be deployed for the second service model. In this case, the rated quantity for model instances of the second service model may be decreased.

If the service traffic is greater than the maximum value of the preset service traffic range, it means that currently deployed model instances of the second service model hardly process all requests. In this case, the rated quantity for model instances of the second service model may be increased.

If the service traffic is within the preset service traffic range, it means that the service traffic of the second service model is within an acceptable range of model instances of the second service model. In this case, the rated quantity for model instances of the second service model does not need to be adjusted.

It can be learned from the above description that when the solution provided by the embodiment of the present disclosure is applied to providing model services for users, and the scaling controller does not adjust the rated quantity for model instances, the quantity of the model instances of the second service model is actually kept at the original rated quantity for model instances, that is, the quantity of model instances which have been created and the original rated quantity for model instances of the second service model are consistent. If the scaling controller adjusts the rated quantity for model instances of the second service model, it can be accurately determined that the quantity of model instances which have been created and an adjusted rated quantity for model instances of the second service model are inconsistent, so that the instance manager 102, the instance scheduler 103 and the running controller 104 may perform corresponding actions to guarantee that the quantity of the model instances and an adjusted rated quantity for model instances of the second service model are kept consistent again, that is, deployment of the model instances of the second service model is guaranteed to meet expectations, thereby improving the reliability of providing model services.

The second trigger situation: The instance manager 102 deletes second model instances of a second service model.

Second model instances of the second service model may be abnormal due to network failure, sudden parameter change and other reasons, and the instance manager 102 may delete the abnormal second model instances. In this case, a quantity of model instances which have been created of the second service model may be decreased, resulting in inconsistency between the quantity of model instances which have been created and a rated quantity for model instances of the second service model. Therefore, if the instance manager 102 deletes the second model instances of the second service model, it can be accurately determined that the quantity of model instances which have been created and the rated quantity for model instances of the second service model are inconsistent, so that the instance manager 102, the instance scheduler 103, and the running controller 104 may perform corresponding actions to guarantee that the quantity of the model instances and an adjusted rated quantity for model instances of the second service model are kept consistent again, that is, deployment of the model instances of the second service model is guaranteed to meet expectations, thereby improving the reliability of providing model services.

The third trigger situation: The running controller 104 deletes second model instances of a second service model.

Inference services 101 may have an abnormal inference service 101 due to host abnormality, service loss and other reasons. If the platform detects that the inference service 101 is abnormal, an instance change event of the inference service 101 may be triggered, so that when monitoring the instance change event of the inference service 101 and determining that the inference service 101 is abnormal, the running controller 104 may delete all model instances bound to the abnormal inference service 101.

For the second service model corresponding to the model instances bound to the abnormal inference service 101, the running controller 104 deletes model instances of the second service model that are bound to the abnormal inference service 101, which reduces a quantity of model instances which have been created of the second service model, thereby resulting in inconsistency between the quantity of model instances which have been created and a rated quantity for model instances of the second service model. Therefore, if the running controller 104 deletes the second model instances of the second service model, it can be accurately determined that the quantity of model instances which have been created and the rated quantity for model instances of the second service model are inconsistent, so that the instance manager 102, the instance scheduler 103 and the running controller 104 may perform corresponding actions to guarantee that the quantity of the model instances and an adjusted rated quantity for model instances of the second service model are kept consistent again, that is, deployment of the model instances of the second service model is guaranteed to meet expectations, thereby improving the reliability of providing model services.

After the running controller 104 deletes the model instances of the second service model bounded to the abnormal model service, the instance manager 102 may re-create model instances of the second service model. The instance scheduler 103 may allocate inference services 101 for newly created model instances in normal inference services 101 except the abnormal inference service 101. The running controller 104 re-calls a loading interface of the inference service 101 allocated for the newly created model instance to mount a weight file of the second service model to a base model encapsulated in the allocated inference services 101.

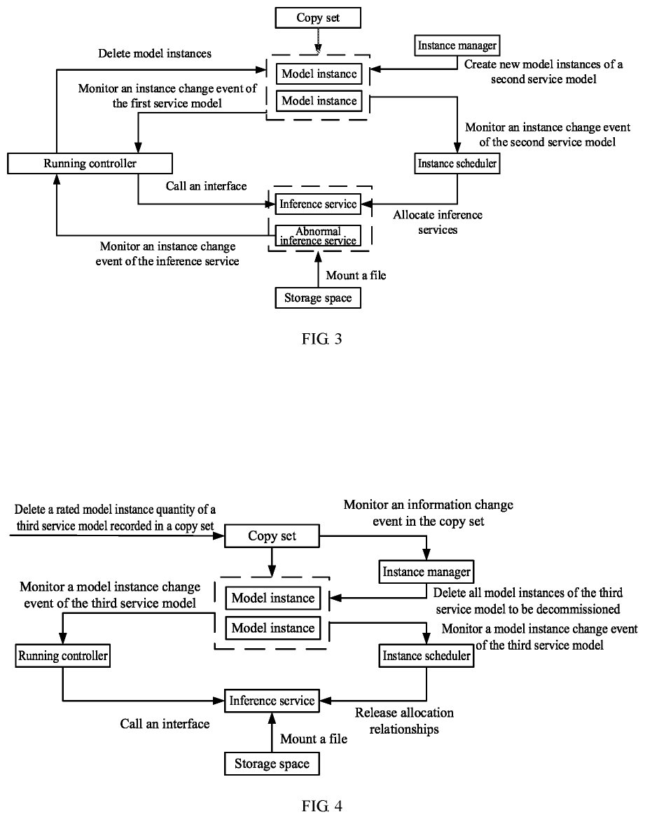

Refer to FIG. 3. FIG. 3 shows a work flow of modules in the platform when an inference service 101 is abnormal.

It can be seen from FIG. 3 that when an inference service 101 is abnormal, the running controller 104 can monitor an instance change event of the inference service 101 and delete all model instances allocated to the abnormal inference service 101. In this case, for a second service model whose model instances are deleted, a quantity of model instances which have been created of the second service model is less than a rated quantity for model instances recorded in a copy set. In this case, the instance manager 102 may create new model instances of the second service model.

After monitoring the instance change event of the second service model, the instance scheduler 103 may allocate inference services 101 for created model instances of the second service model. After monitoring the instance change event of the second service model, the running controller 104 may call a loading interface of the inference service 101 allocated for the model instance of the second service model to mount a weight file of the second service model stored in the storage space to the base model encapsulated in the allocated inference service 101.

Corresponding to deploying a service model to be commissioned to provide model services for users, the platform may further deploy the service model to be decommissioned to stop providing model services for users.

For the case of deploying the service model to be decommissioned, in an embodiment of the present disclosure, the instance manager 102 is further used to delete all third model instances of the third service model in response to a decommissioning instruction for a third service model to be decommissioned.

The decommissioning instruction may be initiated by a user to the platform, or may be triggered by other operations of the platform. For example, the platform may delete a rated quantity for model instances of the third service model to be decommissioned recorded in the instance manager 102, so that it may be considered that the platform issues a decommissioning instruction for the third service model to be decommissioned.

For the content of deleting the third model instances of the third service model by the instance manager 102, reference may be made to the above embodiment, and details are not described herein again.

In a case that the instance manager 102 deletes all third model instances of the third service model, the instance scheduler 103 is further used to release allocation relationships between the third model instances and inference services 101 allocated for the third model instances.

The running controller 104 is further used to call an unloading interface of the inference service 101 allocated for the third model instance to delete a mounted weight file of the third service model from the base model encapsulated in the allocated inference service 101.

For the content of releasing the allocation relationships by the instance scheduler 103 and calling the unloading interface by the running controller 104 to delete the weight file mounted to the base model, reference may be made to the above embodiment, and details are not described herein again.

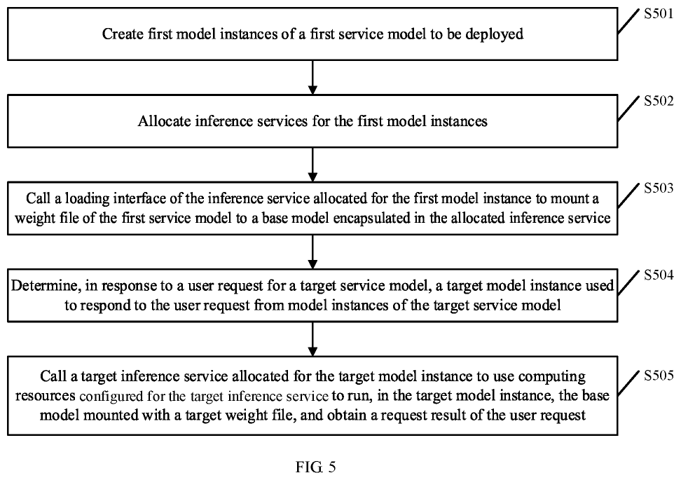

Refer to FIG. 4. FIG. 4 shows a work flow of modules in the platform when the third service model is decommissioned.

It can be seen from FIG. 4 that the platform or the model developer may delete a rated quantity for model instances of the third service model recorded in a copy set. The instance manager 102 monitors an information change event in the copy set, which triggers a decommissioning procedure of the third service model, so that the instance manager 102 deletes all model instances of the third service model to be decommissioned.

After monitoring the model instance change event of the third service model, the instance scheduler 103 may release allocation relationships between model instances of the third service model and inference services 101 allocated for the model instances. After monitoring the model instance change event of the third service model, the running controller 104 may call an unloading interface of the inference service 101 allocated for the model instance of the third service model to delete a mounted weight file of the third service model from the base model encapsulated in the allocated inference service 101.

It can be learned from the above description that when the solution provided by the embodiment of the present disclosure is applied to providing model services for users, the instance manager 102 is further used to delete all third model instances of the third service model in response to the decommissioning instruction for the third service model. The instance scheduler 103 is further used to release the allocation relationships between the third model instances and the inference services 101 allocated for the third model instances. The running controller 104 is further used to call the unloading interface of the inference service 101 allocated for the third model instance to delete the weight file mounted to the base model. Hence, applying the model service providing solution provided by the embodiment of the present disclosure can deploy the service model to be commissioned to provide model services for uses, and further can deploy the service model to be decommissioned to stop providing model services for users, so that the flexibility of providing model services for users can be improved.

Corresponding to the model service providing platform, the embodiments of the present disclosure further provide a model service providing method based on a large model technology.

In an embodiment of the present disclosure, referring to FIG. 5, there is provided a schematic flowchart of a model service providing method applied to a model service providing platform. In this embodiment, the above method includes the following steps S501 to S505.

Step S501: Create first model instances of a first service model to be deployed. The first service model is a large model generated based on a base model.

Step S502: Allocate inference services for the first model instances. The inference services are services obtained by encapsulating the base model, and each inference service is configured with independent computing resources.

Step S503: Call a loading interface of the inference service allocated for the first model instance to mount a weight file of the first service model to the base model encapsulated in the allocated inference service.

Step S504: Determine, in response to a user request for a target service model, a target model instance used to respond to the user request from model instances of the target service model.

Step S505: Call a target inference service allocated for the target model instance to use computing resources configured for the target inference service to run, in the target model instance, a base model mounted with a target weight file, and obtain a request result of the user request, where the target weight file is a weight file of the target service model.

It can be learned from the above description that when the solution provided by the embodiment of the present disclosure is applied to providing model services, each inference service is configured with independent computing resources and the inference services are allocated for the first model instances of each first service model, so that the weight file of the first service model is mounted to the base model encapsulated in the allocated inference service. When the user request for the target service model is received, the target inference service to which the target model instance is allocated can use the configured computing resources to run the base model mounted with the weight file of the target service model. Hence, in the embodiment of the present disclosure, for each user request, the target model instance can be directly determined, and the target inference service allocated for the target model instance uses the computing resources to run the model, so that the purpose of effectively utilizing the computing resources is achieved.

In an embodiment of the present disclosure, when inference services are allocated for first model instances, each first model instance may be allocated to a different inference service based on a quantity of model instances allocated to each inference service.

In this solution, the more model instances allocated to the inference service, the more times the model instance allocated to the service is determined as the target model instance when responding to various requests, and the more frequently the computing resources configured for the service are used. Accordingly, the fewer model instances allocated to the inference service, the less frequently the computing resources configured for the service are used. Allocating an inference service for each first model instance based on the quantity of the model instances allocated to each inference service can guarantee that a relatively uniform quantity of model instances are allocated to each inference service, so that a usage frequency of the computing resources configured for each inference service is not much different, and the situation that computing resources configured for some services are busy whereas computing resources configured for some services are idle can be avoided. Therefore, by applying the solution provided by the embodiment of the present disclosure to provide model services, the computing resources of the platform can be effectively utilized.

In an embodiment of the present disclosure, when inference services are allocated for first model instances, each first model instance may be allocated to a different inference service based on a quantity of idle resources in computing resources configured for each inference service.

In this solution, the inference services are allocated based on the quantity of the idle resources in the computing resources configured for each inference service, so that the computing resources of the platform can be effectively utilized.

In an embodiment of the present disclosure, when inference services are allocated for first model instances, each first model instance may be allocated to a different inference service based on a quantity of model instances allocated to each inference service and a quantity of idle resources in computing resources configured for each inference service.

In this solution, each first model instance is allocated to an inference service with fewer allocated instances and more idle resources and to which model instances of the same first service model are not allocated, so that the computing resources of the platform can be utilized to the greatest extent.

In an embodiment of the present disclosure, when the inference services are allocated for first model instances, different inference services may be allocated from first inference services for the first model instances. A base model encapsulated in the first inference service is a first base model. The first base model is a base model based on which the first service model is generated.

In this solution, the different inference services are allocated from the first inference services for the first model instances. The first inference service encapsulates the first base model based on which the first service model is generated, and the first model instances are model instances of the first service model, so that the inference service can be accurately allocated for each first model instance based on relationships between the first base model, the first service model, the first inference services and the first model instances, thereby improving the accuracy of providing model services.

In an embodiment of the present disclosure, when inference services are allocated for first model instances, candidate inference services to which model instances of the first service model are not allocated may be queried. The candidate inference services are allocated for the first model instances.

In this solution, first, the candidate inference services to which the model instances of the first service model are not allocated are queried, and then the candidate inference services are allocated for the first model instances, which can avoid the plurality of model instances of the first service model being allocated to the same inference service, and avoid the situation that computing resources configured for a part of the inference services are busy whereas computing resources configured for a part of the inference services are idle, so that the computing resources of the platform can be effectively utilized.

In an embodiment of the present disclosure, when a target model instance used to respond to a user request for a target service model is determined from model instances of the target service model in response to the user request, a model list of the first service model corresponding to model instances allocated to each inference service may be obtained. Model instances, of the target service model, for which inference services are allocated are determined based on the model list in response to the user request for the target service model, and the target model instance used to respond to the user request is obtained from the determined model instances.

It can be learned from the above description that when the solution provided by the embodiment of the present disclosure is applied to providing model services for users, the model instances, of the target service model, for which the inference services are allocated can be accurately determined based on the model list, so that the target model instance used to respond to the user request can be accurately obtained from the determined instances, and then the accuracy of providing model services for users can be improved based on the target model instance.

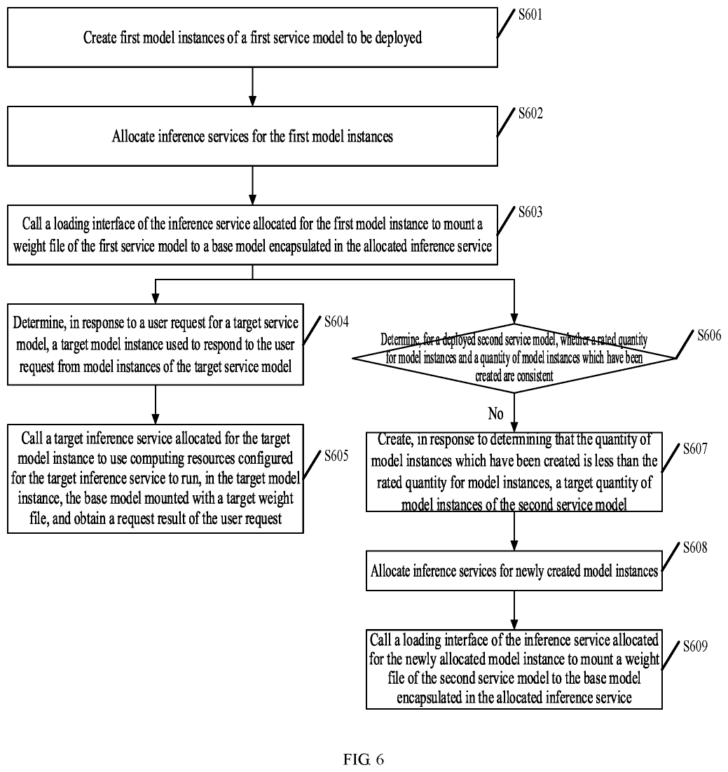

In an embodiment of the present disclosure, referring to FIG. 6, there is provided a schematic flowchart of a second model service providing method. In this embodiment, the above method includes the following steps S601 to S609.

Step S601: Create first model instances of a first service model to be deployed. The first service model is a large model generated based on a base model.

Step S602: Allocate inference services for the first model instances. The inference services are services obtained by encapsulating the base model, and each inference service is configured with independent computing resources.

Step S603: Call a loading interface of the inference service allocated for the first model instance to mount a weight file of the first service model to the base model encapsulated in the allocated inference service.

Step S604: Determine, in response to a user request for a target service model, a target model instance used to respond to the user request from model instances of the target service model.

Step S605: Call a target inference service allocated for the target model instance to use computing resources configured for the target inference service to run, in the target model instance, a base model mounted with a target weight file, and obtain a request result of the user request. The target weight file is a weight file of the target service model.

Step S606: Determine, for a deployed second service model, whether a rated quantity for model instances and a quantity of model instances which have been created are consistent, and if the quantities are inconsistent, perform step S607.

Step S607: Create, in response to determining that the quantity of model instances which have been created is less than the rated quantity for model instances, a target quantity of model instances of the second service model. The target quantity is a difference between the quantity of model instances which have been created and the rated quantity for model instances.

Step S608: Allocate inference services for newly created model instances.

Step S609: Call a loading interface of the inference service allocated for the newly allocated model instance to mount a weight file of the second service model to the base model encapsulated in the allocated inference service.

In this solution, when the quantity of model instances which have been created of the second service model is less than the rated quantity for model instances, the target quantity of model instances of the second service model are created, so that the model instances which have been created of the second service model can reach the rated quantity for model instances, and the rated quantity for model instances may be understood as a quantity of model instances of the second service model that are expected to be deployed. Therefore, creating the target quantity of model instances can guarantee that deployment of the second service model meets expectations, thereby improving the reliability of providing model services.

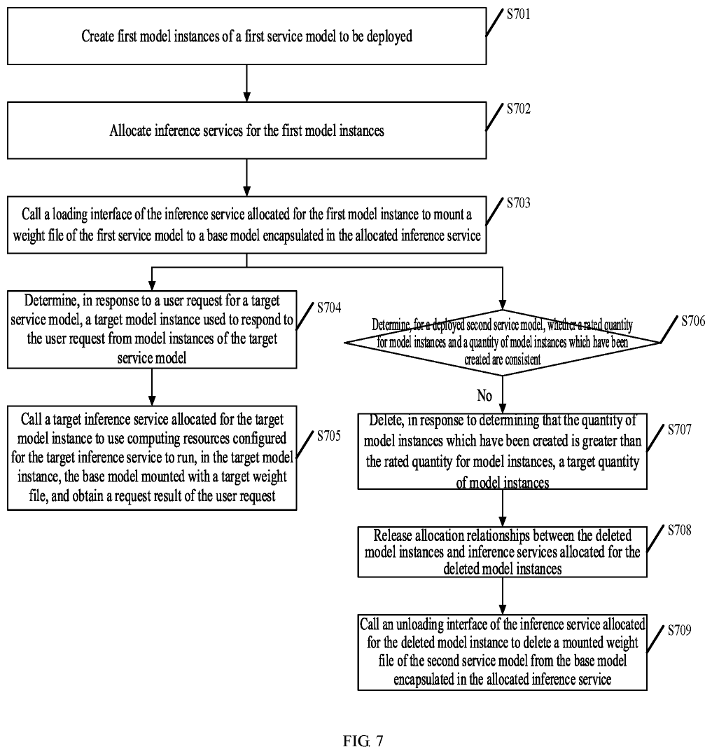

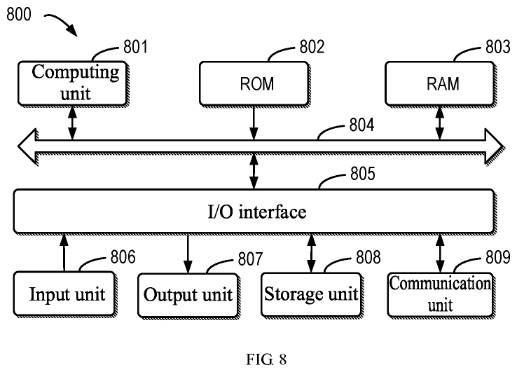

In an embodiment of the present disclosure, referring to FIG. 7, there is provided a schematic flowchart of a second model service providing method. In this embodiment, the above method includes the following steps S701 to S709.

Step S701: Create first model instances of a first service model to be deployed. The first service model is a large model generated based on a base model.

Step S702: Allocate inference services for the first model instances. The inference services are services obtained by encapsulating the base model, and each inference service is configured with independent computing resources.

Step S703: Call a loading interface of the inference service allocated for the first model instance to mount a weight file of the first service model to the base model encapsulated in the allocated inference service.

Step S704: Determine, in response to a user request for a target service model, a target model instance used to respond to the user request from model instances of the target service model.

Step S705: Call a target inference service allocated for the target model instance to use computing resources configured for the target inference service to run, in the target model instance, a base model mounted with a target weight file, and obtain a request result of the user request. The target weight file is a weight file of the target service model.

Step S706: Determine, for a deployed second service model, whether a rated quantity for model instances and a quantity of model instances which have been created are consistent, and if the quantities are inconsistent, perform step S707.

Step S707: Delete, in response to determining that the quantity of model instances which have been created is greater than the rated quantity for model instances, a target quantity of model instances. The target quantity is a difference between the quantity of model instances which have been created and the rated quantity for model instances.

Step S708: Release allocation relationships between deleted model instances and inference services allocated for the deleted model instances.

Step S709: Call an unloading interface of the inference service allocated for the deleted model instance to delete a mounted weight file of the second service model from the base model encapsulated in the allocated inference service.

In this solution, in a case that the quantity of model instances which have been created of the second service model is greater than the rated quantity for model instances, the target quantity of model instances of the second service model are deleted, so that the created model instances of the second service model can also reach the rated quantity for model instances, which guarantees that deployment of the second service model meets expectations, thereby improving the reliability of providing model services.

In an embodiment of the present disclosure, inconsistency between the rated quantity for model instances and the quantity of model instances which have been created of the second service model is triggered by at least one of following situations:

The first situation: The rated quantity for model instances of the second service model is adjusted based on monitored service traffic of the second service model.

In this case, when the rated quantity for model instances is not adjusted, the quantity of model instances of the second service model is actually kept at the original rated quantity for model instances, that is, the quantity of model instances which have been created and the original rated quantity for model instances of the second service model are consistent. If the rated quantity for model instances of the second service model is adjusted, it can be accurately determined that the quantity of model instances which have been created and the adjusted rated quantity for model instances of the second service model are inconsistent, so that corresponding actions are performed subsequently to guarantee that the quantity of the model instances and an adjusted rated quantity for model instances of the second service model are kept consistent again, that is, deployment of the model instances of the second service model is guaranteed to meet expectations, thereby improving the reliability of providing model services.

The second situation: One or more second model instances of the second service model are deleted.

In this case, if the one or more second model instances of the second service model are deleted, it can be accurately determined that the quantity of model instances which have been created and the rated quantity for model instances of the second service model are inconsistent, so that corresponding actions are performed subsequently to guarantee that the quantity of model instances and an adjusted rated quantity for model instances of the second service model are kept consistent again, that is, deployment of the model instances of the second service model is guaranteed to meet expectations, thereby improving the reliability of providing model services.

In an embodiment of the present disclosure, when the rated quantity for model instances of the second service model is adjusted based on monitored service traffic of the second service model, the service traffic of the second service model can be monitored. Change information that represents a traffic change trend of the second service model is determined based on the monitored service traffic. The rated quantity for model instances of the second service model is adjusted based on the change information.

In this solution, the change information that represents the traffic change trend of the second service model is determined based on the monitored service traffic of the second service model. The rated quantity for model instances of the second service model can be adaptively adjusted based on the change information while considering the traffic change trend of the second service model. As the rated quantity for model instances is adjusted, the quantity of model instances which have been created and the rated quantity for model instances of the second service model are inconsistent, so that corresponding actions are performed subsequently, and the quantity of model instances which have been created of the second service model can be adjusted with the traffic change trend, thereby avoiding the shortage or idleness of computing resources caused by too many model instances or too few model instances of the second service model. Therefore, applying the service model providing solution provided by the embodiment of the present disclosure can effectively utilize the computing resources of the platform.

According to an embodiment of the present disclosure, the above method further includes:
deleting, in response to a decommissioning instruction for a third service model, all third model instances of the third service model;
releasing allocation relationships between the third model instances and inference services allocated for the third model instances; and
calling, for each third model instance of the third model instances, an unloading interface of an inference service allocated for the third model instance to delete a mounted weight file of the third service model from a base model encapsulated in the inference service allocated for the third model instance.

It can be learned from the above description that when the solution provided by the embodiment of the present disclosure is applied to providing model services for users, in response to the decommissioning instruction of the third service model, all third model instances of the third service models are deleted, the allocation relationships between the third model instances and the inference services allocated for the third model instances are released, and the unloading interface of the inference service allocated for the third model instance is called to delete the weight file mounted to the base model. Hence, applying the model service providing solution provided by the embodiment of the present disclosure can deploy the service model to be commissioned to provide model services for users, and further can deploy the service model to be decommissioned to stop providing model services for users, so that the flexibility of providing model services for users can be improved.

According to an embodiment of the present disclosure, the above method further includes:
monitoring a state of each first model instance of the plurality of first model instances: wherein
the allocating the inference service for each of the plurality of the first model instances comprises:
allocating the inference services for one or more first model instances of the plurality of first model instances, wherein the state of each first model instance of the one or more first model instances represents that the first model instance has been created but a service has not allocated for the first model instance; and wherein
the calling, for each first model instance of the plurality of first model instances, the loading interface of the inference service allocated for the first model instance to mount the weight file of the first service model to the base model encapsulated in the inference service comprises:
for each first model instance of the plurality of first model instances, calling, in response to determining the state of the first model instance represents that the first model instance has been allocated the inference service but has not been bound to the inference service, a loading interface of the inference service allocated for the first model instance to mount the weight file of the first service model to the base model encapsulated in the inference service.

It can be learned from the above description that when the solution provided by the embodiment of the present disclosure is applied to providing model services for users, the state of each first model instance is monitored, and then the first model instances in various states can be processed accordingly and accurately based on the state of each first model instance. Hence, applying the model service providing solution provided by the embodiment of the present disclosure can improve the accuracy of providing model services for users.

In the technical solutions of the present disclosure, collection, storage, use, processing, transmission, provision, disclosure, etc. of user personal information involved all comply with related laws and regulations and are not against the public order and good morals.

According to an embodiment of the present disclosure, the present disclosure further provides an electronic device, a readable storage medium, and a computer program product.

In an embodiment of the present disclosure, there is provided an electronic device, including:
at least one processor; and
a memory communicatively connected to the at least one processor, where
the memory stores instructions executable by the at least one processor, and the instructions, when executed by the at least one processor, cause the at least one processor to perform any model service providing method in the above method embodiments.

In an embodiment of the present disclosure, there is provided a non-transitory computer-readable storage medium storing computer instructions, where the computer instructions are used to cause the computer to perform any model service providing method in the above method embodiments.

In an embodiment of the present disclosure, there is provided a computer program product, including a computer program, where when the computer program is executed by a processor, any model service providing method in the above method embodiments is implemented.

FIG. 8 is a schematic block diagram of an example electronic device 800 that can be used to implement an embodiment of the present disclosure. The electronic device is intended to represent various forms of digital computers, such as a laptop computer, a desktop computer, a workstation, a personal digital assistant, a server, a blade server, a mainframe computer, and other suitable computers. The electronic device may further represent various forms of mobile apparatuses, such as a personal digital assistant, a cellular phone, a smartphone, a wearable device, and other similar computing apparatuses. The components shown in the present specification, their connections and relationships, and their functions are merely examples, and are not intended to limit the implementation of the present disclosure described and/or required herein.

As shown in FIG. 8, the device 800 includes a computing unit 801. The computing unit may perform various appropriate actions and processing according to a computer program stored in a read-only memory (ROM) 802 or a computer program loaded from a storage unit 808 to a random access memory (RAM) 803. Various programs and data required for the operation of the device 800 may also be stored in RAM 803. The computing unit 801, the ROM 802, and the RAM 803 are connected to each other through a bus 804. An input/output (I/O) interface 805 is also connected to the bus 804.

A plurality of components in the device 800 are connected to the I/O interface 805, including: an input unit 806, such as a keyboard and a mouse: an output unit 807, such as various types of displays and speakers: a storage unit 808, such as a magnetic disk and an optical disc; and a communication unit 809, such as a network card, a modem, and a wireless communication transceiver. The communication unit 809 allows the device 800 to exchange information/data with other devices via a computer network such as the Internet and/or various telecommunications networks.

The computing unit 801 may be various general-purpose and/or special-purpose processing components with processing and computing capabilities. Some examples of the computing unit 801 include, but are not limited to, a central processing unit (CPU), a graphics processing unit (GPU), various dedicated artificial intelligence (AI) computing chips, various computing units that run machine learning model algorithms, a digital signal processor (DSP), and any appropriate processor, controller, microcontroller, etc. The computing unit 801 performs the various methods and processing described above, for example, the model service providing method. For example, in some embodiments, the model service providing method may be implemented as a computer software program, which is tangibly contained in a machine-readable medium, such as the storage unit 808. In some embodiments, part or all of the computer programs may be loaded and/or installed onto the device 800 via the ROM 802 and/or the communication unit 809. When the computer program is loaded onto the RAM 803 and executed by the computing unit 801, one or more steps of the model service providing method described above can be performed. Alternatively, in other embodiments, the computing unit 801 may be configured, by any other appropriate means (for example, by means of firmware), to perform the model service providing method.

Various implementations of the systems and technologies described herein above can be implemented in a digital electronic circuit system, an integrated circuit system, a field programmable gate array (FPGA), an application-specific integrated circuit (ASIC), an application-specific standard product (ASSP), a system-on-chip (SOC) system, a complex programmable logical device (CPLD), computer hardware, firmware, software, and/or a combination thereof. These various implementations may include: implementation in one or more computer programs, where the one or more computer programs may be executed and/or interpreted on a programmable system including at least one programmable processor. The programmable processor may be a dedicated or general-purpose programmable processor that can receive data and instructions from a storage system, at least one input apparatus, and at least one output apparatus, and transmit data and instructions to the storage system, the at least one input apparatus, and the at least one output apparatus.

Program codes used to implement the method of the present disclosure can be written in any combination of one or more programming languages. These program codes may be provided for a processor or a controller of a general-purpose computer, a special-purpose computer, or other programmable data processing apparatuses, such that when the program codes are executed by the processor or the controller, the functions/operations specified in the flowcharts and/or block diagrams are implemented. The program codes may be completely executed on a machine, or partially executed on a machine, or may be, as an independent software package, partially executed on a machine and partially executed on a remote machine, or completely executed on a remote machine or a server.

In the context of the present disclosure, the machine-readable medium may be a tangible medium, which may contain or store a program for use by an instruction execution system, apparatus, or device, or for use in combination with the instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof.

In order to provide interaction with a user, the systems and technologies described herein can be implemented on a computer which has: a display apparatus (for example, a cathode-ray tube (CRT) or a liquid crystal display (LCD) monitor) configured to display information to the user; and a keyboard and a pointing apparatus (for example, a mouse or a trackball) through which the user can provide an input to the computer. Other categories of apparatuses can also be used to provide interaction with the user: for example, feedback provided to the user can be any form of sensory feedback (for example, visual feedback, auditory feedback, or tactile feedback), and an input from the user can be received in any form (including an acoustic input, a voice input, or a tactile input).

The systems and technologies described herein can be implemented in a computing system (for example, as a data server) including a backend component, or a computing system (for example, an application server) including a middleware component, or a computing system (for example, a user computer with a graphical user interface or a web browser through which the user can interact with the implementation of the systems and technologies described herein) including a frontend component, or a computing system including any combination of the backend component, the middleware component, or the frontend component. The components of the system can be connected to each other through digital data communication (for example, a communication network) in any form or medium. Examples of the communication network include: a local area network (LAN), a wide area network (WAN), and the Internet.

A computer system may include a client and a server. The client and the server are generally far away from each other and usually interact through a communication network. A relationship between the client and the server is generated by computer programs running on respective computers and having a client-server relationship with each other. The server may be a cloud server, a server in a distributed system, or a server combined with a blockchain.

It should be understood that steps may be reordered, added, or deleted based on the various forms of procedures shown above. For example, the steps recorded in the present disclosure may be performed in parallel, in order, or in a different order, provided that the desired result of the technical solutions disclosed in the present disclosure can be achieved, which is not limited herein.

The specific implementations above do not constitute a limitation on the protection scope of the present disclosure. Those skilled in the art should understand that various modifications, combinations, sub-combinations, and replacements can be made based on design requirements and other factors. Any modifications, equivalent replacements, improvements, etc. within the spirit and principle of the present disclosure shall fall within the protection scope of the present disclosure.

1. A method for providing model service, wherein the method is based on a model service providing platform, wherein the model service providing platform includes a plurality of inference services, and wherein the method comprises:
creating a plurality of first model instances of a first service model to be deployed, wherein the first service model is a large model generated based on a base model;
allocating an inference service for each first model instance of the plurality of first model instances from the plurality of inference services, wherein the plurality of inference services are obtained by encapsulating the base model, and each inference service of the plurality of inference services is configured with independent computing resources;
calling, for each first model instance of the plurality of first model instances, a loading interface of the inference service allocated for the first model instance to mount a weight file of the first service model to the base model encapsulated in the inference service allocated for the first model instance;
determining, in response to a user request for a target service model, a target model instance from a plurality of model instances of the target service model to respond to the user request; and
calling a target inference service allocated for the target model instance to use computing resources configured for the target inference service to run, in the target model instance, a base model mounted with a target weight file, and obtain a request result of the user request, wherein the target weight file is a weight file of the target service model.

2. The method according to claim 1, wherein the allocating the inference service for each first model instance of the plurality of first model instances from the plurality of inference services comprises:
allocating each first model instance of the plurality of first model instances to a different inference service in the plurality of inference services, based on a quantity of model instances allocated to each inference service and/or a quantity of idle resources in computing resources configured for each inference service.

3. The method according to claim 1, wherein the allocating the inference service for each first model instance of the plurality of first model instances from the plurality of inference services comprises:
allocating a different inference service from a plurality of first inference services for each first model instance of the plurality of first model instances, wherein each first inference service of the plurality of first inference services is obtained by encapsulating a first base model, and wherein the first base model is used to generate the first service model.

4. The method according to claim 1, wherein the allocating the inference service for each first model instance of the plurality of first model instances from the plurality of inference services comprises performing, for each first model instance of the plurality of first model instances, operations comprising:
querying, from the plurality of inference services, one or more candidate inference services to which a model instance of the first service model is not allocated; and
allocating a candidate inference service from the one or more candidate inference services for the first model instance.

5. The method according to claim 1, wherein the determining, in response to the user request for the target service model, the target model instance from the plurality of model instances of the target service model to respond to the user request comprises:
obtaining a model list corresponding to each inference service of the plurality of inference services, wherein the model list includes one or more service model corresponding to one or more model instances allocated to a corresponding inference service; and
in response to the user request for the target service model, determining the plurality of model instances of the target service model, for which inference services are allocated, based on the model list corresponding to each of the plurality of inference services, to obtain the target model instance from the plurality of model instances.

6. The method according to claim 1, further comprising:
determining, for a deployed second service model, whether a rated quantity for model instances and a quantity of model instances which have been created are consistent;
determining, in response to determining that the rated quantity for model instances and the quantity of model instances which have been created are inconsistent, whether the quantity of model instances which have been created is less than the rated quantity for model instances;
creating, in response to determining that the quantity of model instances which have been created is less than the rated quantity for model instances, a first target quantity of model instances of the second service model, wherein the first target quantity is a difference between the quantity of model instances which have been created and the rated quantity for model instances;
allocating an inference service for each newly created model instance of a plurality of newly created model instances;
calling, for each newly created model instance of the plurality of newly created model instances, a loading interface of an inference service allocated for the newly allocated model instance to mount a weight file of the second service model to a base model encapsulated in the inference service allocated for the newly allocated model;
deleting, in response to determining that the quantity of model instances which have been created is greater than the rated quantity for model instances, a second target quantity of model instances, wherein the second target quantity is a difference between the quantity of model instances which have been created and the rated quantity for model instances;
releasing allocation relationships between deleted model instances and inference services allocated for the deleted model instances; and
calling, for each deleted model instance of the deleted model instances, an unloading interface of an inference service allocated for the deleted model instance to delete a mounted weight file of the second service model from a base model encapsulated in the inference service allocated for the deleted model instance.

7. The method according to claim 6, wherein inconsistency between the rated quantity for model instances and the quantity of model instances which have been created of the second service model is triggered by at least one of following operations:
adjusting the rated quantity for model instances of the second service model based on monitored service traffic of the second service model; and
deleting one or more second model instances of the second service model.

8. The method according to claim 7, wherein the adjusting the rated quantity for model instances of the second service model based on the monitored service traffic of the second service model comprises:
monitoring service traffic of the second service model;
determining change information that represents a traffic change trend of the second service model based on the monitored service traffic; and
adjusting the rated quantity for model instances of the second service model based on the change information.

9. The method according to claim 1, further comprising:
deleting, in response to a decommissioning instruction for a third service model, all third model instances of the third service model;
releasing allocation relationships between the third model instances and inference services allocated for the third model instances; and
calling, for each third model instance of the third model instances, an unloading interface of an inference service allocated for the third model instance to delete a mounted weight file of the third service model from a base model encapsulated in the inference service allocated for the third model instance.

10. The method according to claim 1, further comprising:
monitoring a state of each first model instance of the plurality of first model instances;
wherein the allocating the inference service for each first model instance of the plurality of the first model instances comprises:
allocating the inference services for one or more first model instances of the plurality of first model instances, wherein the state of each first model instance of the one or more first model instances represents that the first model instance has been created but a service has not allocated for the first model instance; and
wherein the calling, for each first model instance of the plurality of first model instances, the loading interface of the inference service allocated for the first model instance to mount the weight file of the first service model to the base model encapsulated in the inference service comprises:
for each first model instance of the plurality of first model instances, calling, in response to determining the state of the first model instance represents that the first model instance has been allocated the inference service but has not been bound to the inference service, a loading interface of the inference service allocated for the first model instance to mount the weight file of the first service model to the base model encapsulated in the inference service.

11. An electronic device, comprising:
at least one processor; and
a memory communicatively connected to the at least one processor, wherein the memory stores instructions executable by the at least one processor, and the instructions, when executed by the at least one processor, cause the at least one processor to perform operations based on a model service providing platform, wherein the model service providing platform includes a plurality of inference services, and wherein the operations comprise:
creating a plurality of first model instances of a first service model to be deployed, wherein the first service model is a large model generated based on a base model;
allocating an inference service for each first model instance of the plurality of first model instances from the plurality of inference services, wherein the plurality of inference services are obtained by encapsulating the base model, and each inference service of the plurality of inference services is configured with independent computing resources;
calling, for each first model instance of the plurality of first model instances, a loading interface of the inference service allocated for the first model instance to mount a weight file of the first service model to the base model encapsulated in the inference service allocated for the first model instance;
determining, in response to a user request for a target service model, a target model instance from a plurality of model instances of the target service model to respond to the user request; and
calling a target inference service allocated for the target model instance to use computing resources configured for the target inference service to run, in the target model instance, a base model mounted with a target weight file, and obtain a request result of the user request, wherein the target weight file is a weight file of the target service model.

12. The electronic device according to claim 11, wherein the allocating the inference service for each first model instance of the plurality of first model instances from the plurality of inference services comprises:
allocating each first model instance of the plurality of first model instances to a different inference service in the plurality of inference services, based on a quantity of model instances allocated to each inference service and/or a quantity of idle resources in computing resources configured for each inference service.

13. The electronic device according to claim 11, wherein the allocating the inference service for each first model instance of the plurality of first model instances from the plurality of inference services comprises:
allocating a different inference service from a plurality of first inference services for each first model instance of the plurality of first model instances, wherein each first inference service of the plurality of first inference services is obtained by encapsulating a first base model, and wherein the first base model is used to generate the first service model.

14. The electronic device according to claim 11, wherein the allocating the inference service for each first model instance of the plurality of first model instances from the plurality of inference services comprises performing, for each of the plurality of first model instances, operations comprising:
querying, from the plurality of inference services, one or more candidate inference services to which a model instance of the first service model is not allocated; and
allocating a candidate inference service from the one or more candidate inference services for the first model instance.

15. The electronic device according to claim 11, wherein the determining, in response to the user request for the target service model, the target model instance from the plurality of model instances of the target service model to respond to the user request comprises:
obtaining a model list corresponding to each inference service of the plurality of inference services, wherein the model list includes one or more service model corresponding to one or more model instances allocated to a corresponding inference service; and
in response to the user request for the target service model, determining the plurality of model instances of the target service model, for which inference services are allocated, based on the model list corresponding to each of the plurality of inference services, to obtain the target model instance from the plurality of model instances.

16. The electronic device according to claim 11, wherein the operations performed by the at least one processor further comprise:
determining, for a deployed second service model, whether a rated quantity for model instances and a quantity of model instances which have been created are consistent;
determining, in response to determining that the rated quantity for model instances and the quantity of model instances which have been created are inconsistent, whether the quantity of model instances which have been created is less than the rated quantity for model instances;
creating, in response to determining that the quantity of model instances which have been created is less than the rated quantity for model instances, a first target quantity of model instances of the second service model, wherein the first target quantity is a difference between the quantity of model instances which have been created and the rated quantity for model instances;
allocating an inference service for each newly created model instance of a plurality of newly created model instances;
calling, for each newly created model instance of the plurality of newly created model instances, a loading interface of an inference service allocated for the newly allocated model instance to mount a weight file of the second service model to a base model encapsulated in the inference service allocated for the newly allocated model;
deleting, in response to determining that the quantity of model instances which have been created is greater than the rated quantity for model instances, a second target quantity of model instances, wherein the second target quantity is a difference between the quantity of model instances which have been created and the rated quantity for model instances;
releasing allocation relationships between deleted model instances and inference services allocated for the deleted model instances; and
calling, for each deleted model instance of the deleted model instances, an unloading interface of an inference service allocated for the deleted model instance to delete a mounted weight file of the second service model from a base model encapsulated in the inference service allocated for the deleted model instance.

17. The electronic device according to claim 16, wherein inconsistency between the rated quantity for model instances and the quantity of model instances which have been created of the second service model is triggered by at least one of following operations:
adjusting the rated quantity for model instances of the second service model based on monitored service traffic of the second service model; and
deleting one or more second model instances of the second service model.

18. The electronic device according to claim 17, wherein the adjusting the rated quantity for model instances of the second service model based on the monitored service traffic of the second service model comprises:
monitoring service traffic of the second service model;
determining change information that represents a traffic change trend of the second service model based on the monitored service traffic; and
adjusting the rated quantity for model instances of the second service model based on the change information.

19. The electronic device according to claim 11, wherein the operations performed by the at least one processor further comprise:
deleting, in response to a decommissioning instruction for a third service model, all third model instances of the third service model;
releasing allocation relationships between the third model instances and inference services allocated for the third model instances; and
calling, for each third model instance of the third model instances, an unloading interface of an inference service allocated for the third model instance to delete a mounted weight file of the third service model from a base model encapsulated in the inference service allocated for the third model instance.

20. A non-transitory computer-readable storage medium storing computer instructions, wherein the computer instructions when executed are used to cause a computer to perform operations based on a model service providing platform, wherein the model service providing platform includes a plurality of inference services, and wherein the operations comprise:
creating a plurality of first model instances of a first service model to be deployed, wherein the first service model is a large model generated based on a base model;
allocating an inference service for each first model instance of the plurality of first model instances from the plurality of inference services, wherein the plurality of inference services are obtained by encapsulating the base model, and each inference service of the plurality of inference services is configured with independent computing resources;
calling, for each first model instance of the plurality of first model instances, a loading interface of the inference service allocated for the first model instance to mount a weight file of the first service model to the base model encapsulated in the inference service allocated for the first model instance;
determining, in response to a user request for a target service model, a target model instance from a plurality of model instances of the target service model to respond to the user request; and
calling a target inference service allocated for the target model instance to use computing resources configured for the target inference service to run, in the target model instance, a base model mounted with a target weight file, and obtain a request result of the user request, wherein the target weight file is a weight file of the target service model.
